(19) United States
(12) Patent Application Publication
(10) Pub. No.: US 2022/0292394 A1
(43) Pub. Date: Sep. 15, 2022

(54) MULTI-SCALE DEEP SUPERVISION BASED REVERSE ATTENTION MODEL

(71) Applicant: Tongji university, Shanghai (CN)

(72) Inventors: Deshuang Huang, Shanghai (CN); Di Wu, Zhengzhou (CN); Changan Yuan, Nanning City (CN); Zhongqiu Zhao, Hefei City (CN); Jianbin Huang, Xi'an City (CN)

(21) Appl. No.: 17/401,632

(22) Filed: Aug. 13, 2021

(30) Foreign Application Priority Data
Mar. 12, 2021 (CN) 202110266638X

(51) Int. Cl. G06N 20/00; G06K 9/62; G06K 9/00

(52) U.S. Cl. CPC G06N 20/00; G06K 9/6232; G06K 9/6288; G06K 9/00362

(57) ABSTRACT

A multi-scale deep supervision based reverse attention model is provided and includes an input end, a multi-scale feature learning module, an attention mechanism module, a reverse attention mechanism module, a deep supervision module, multiple loss functions, multiple average pool layers, multiple linear layers and multiple branches. The reverse attention mechanism module as provided can alleviate the problem of feature information loss caused by attention mechanisms, and part of the modules can be discarded in the testing phase, thereby improving the testing efficiency.

### TECHNICAL FIELD OF THE INVENTION

The invention relates to the field of person re-identification, and in particular, to a multi-scale deep supervision based reverse attention model.

### BACKGROUND OF THE INVENTION

Person re-identification (PReID) is a task of automatically determining whether persons captured by different traffic cameras or captured by the same traffic camera at different time points are the same person. Due to its important role in the application of intelligent video surveillance systems, person re-identification has attracted extensive attention in the field of computer vision in recent years. Because the resolution of person pictures taken in real scenes is low, and traditional biometric information cannot be accurately acquired, at present, in this task, identification is performed mainly based on the appearance features of persons. However, person pictures taken in different scenes and at different time points have differences in illumination, posture, angle of view, and background, and even a situation that the posture and facial features of different persons are more similar than those of the same person exists, which makes person re-identification become a challenging computer vision task. Recently, the deep learning technology is successfully applied in the field of person re-identification, which greatly promotes the development of the field. In a deep learning based person re-identification method, feature learning and metric learning are integrated into an end-to-end deep model by using the better learning capacity of a deep neural network. It is worth mentioning that in the past two years, almost all the most advanced models in the field of person re-identification are deployed based on the deep learning technology.

Moreover, in the field of person re-identification, besides deep local feature learning networks, many advanced methods are also attention mechanism or multi-scale feature learning based network models. In an attention mechanism based network model, spatial attention and channel attention are introduced into a backbone network, so that the model can automatically carry out re-weighting processing on spatial features and channel features. However, while these features are re-weighted, some features are emphasized and the attention of other features is weakened, which results in the information loss of some important features. In a multi-scale feature learning based network model, a multi-scale feature learning module is often embedded into a feature extraction network, although this embedding operation can improve the feature learning capacity of the model to some extent, the complexity of the network model will be increased, thus, it is urgent to find a model that can solve the problems in the prior art.

### SUMMARY OF THE INVENTION

The invention is designed to provide a multi-scale deep supervision based reverse attention model, so that problems existing in the prior art are solved, neglected feature information is noticed, multi-scale information is introduced while mid-hierarchy information is corrected, and part of modules can be discarded in the testing phase, thereby improving the time efficiency of testing.

For achieving the foregoing objectives, the invention provides the following scheme:

the invention provides a multi-scale deep supervision based reverse attention model, which includes an input end, a multi-scale feature learning module, an attention mechanism module, a reverse attention mechanism module, a deep supervision module, a plurality of loss functions, a plurality of average pool layers, a plurality of linear layers and a plurality of branches, where

the input end is configured to input features of different hierarchies extracted from a plurality of person pictures;

the multi-scale feature learning module is configured (i.e., structured and arranged) to carry out multi-scale learning and training on the features, and includes a first phase, a second phase, a third phase and a fourth phase, and each phase inputs a feature set and outputs a feature map;

the attention mechanism module is configured to strengthen an attention to local important feature information;

the reverse attention mechanism module is configured to change features suppressed by the attention mechanism module into emphasized features, and is complementary to the attention mechanism module;

the deep supervision module is configured to correct an accuracy of the attention of the attention mechanism module to important features;

the branches include a branch 1, a branch 2, a branch 3, a branch 4 and a branch 5;

the multi-scale feature learning module, the reverse attention module, the average pool layers and the loss functions are successively connected;

the second phase of the multi-scale feature learning module is successively connected to the deep supervision module, the branch 5 and the loss functions through the attention mechanism module;

the third phase of the multi-scale feature learning module is successively connected to the deep supervision module, the branch 4 and the loss functions through the attention mechanism module;

the first, second, third and fourth phases of the multi-scale feature learning module, the average pool layers and the branch 2 are successively connected;

the branch 2 is directly connected to the loss functions; and

the branch 2 is also connected to the loss functions through the branch 3.

Further, a single-dimensional convolution operation is performed in the multi-scale feature learning module.

Further, the attention mechanism module includes a channel attention module and a spatial attention module, the channel attention module is configured to output a set of weight values to feature channels, the spatial attention module is configured to strengthen the attention to local important feature information, the channel attention module and the spatial attention module are both configured to process feature maps outputted by each phase of the multi-scale feature learning module, and the channel attention module and the spatial attention module are fused:

ATT=σ(ATT_{C}×ATT_{S})

where ATT refers to an output of the entire attention mechanism module, σ refers to a Sigmoid function, ATT_{C} refers to the output of the channel attention module, and ATT_{S} refers to an output of the spatial attention module.

Further, the channel attention module includes an average pool layer and two linear layers, and the output of the channel attention module is implemented through steps that: firstly, the feature map passes through the average pool layer to carry out a global average pool operation; then, the feature map passes through the two linear layers, a first one of the two linear layers is configured to reduce the number of parameters, and a second one of the two linear layers is configured to recover the number of channels; and finally, a batch normalization operation is performed on the feature map after passing through the two linear layers, so that a range of output values and a range of channel attention values are adjusted to be consistent.

Further, the spatial attention module includes two convolutional layers and two dimensionality reduction layers, and the output of the spatial attention module is implemented through steps that: firstly, the feature map passes through one of the two dimensionality reduction layers to carry out dimensionality reduction; then, the feature map is successively inputted into the two convolutional layers, and then enters the other one of the two dimensionality reduction layers to carry out further dimensionality reduction; and finally, the batch normalization operation is performed on the feature map.

Further, in the reverse attention mechanism module, a method for changing the suppressed feature into emphasized feature is implemented by taking a dot product of a feature outputted by each phase and an output, where the output is:

ATT_{R}=1−σ(ATT_{C}×ATT_{S})

where, ATT_{R} is the output of the reverse attention mechanism module.

Further, the deep supervision module is also configured to simultaneously carry out deep supervision on the model and introduce multi-scale information in a feature learning process.

Further, the plurality of loss functions include four identification loss functions, four smoothed cross entropy loss functions and a triple loss function; the four identification loss functions include an ID loss1, an ID loss2, an ID loss3 and an ID loss4, the four smoothed cross entropy loss functions are respectively configured to train the branch 1, the branch 3, the branch 4 and the branch 5, and the triple loss function is a ranked list loss function.

Further, the ID loss1 is configured to supervise the learning of the reverse attention mechanism module, the ID loss2 and the triple loss function are respectively configured to learn global features and corresponding distance measurement methods, and the ID loss3 and the ID loss4 are configured to perform deep multi-scale feature supervision operations.

Further, the deep supervision module, the reverse attention mechanism module, the loss functions, the branch 1, the branch 2, the branch 4 and the branch 5 only participate in the training of the model, and need to be discarded in a predicting process, thus, the model in the predicting process only includes the input end, the multi-scale feature learning module, the attention mechanism module, the average pool layers, the linear layers and the branch 3.

The invention discloses the following technical effects:

the invention provides a multi-scale deep supervision based reverse attention model, a multi-scale deep supervision module is introduced on this basis, and the multi-scale deep supervision module can introduce multi-scale information on the basis of carrying out learning correction on mid-hierarchy features; and the introduction of reverse attention is helpful for the network model to notice those feature information ignored by the attention module. The provided reverse attention module and the multi-scale deep supervision module are both configured to support the learning of the network model only in the training phase, and will be discarded in the testing phase, thereby improving the timeliness of the network in the testing phase. Experimental results show that the provided network model achieves the most advanced performance at this time.

### BRIEF DESCRIPTION OF THE FIGURES

To illustrate the technical solutions in the embodiments of the invention or the prior art more clearly, the following briefly introduces the accompanying drawings required for describing the embodiments. Apparently, the accompanying drawings in the following descriptions show merely some of the embodiments of the invention, and a person of ordinary skill in the art may still derive other drawings from the accompanying drawings without creative efforts.

FIG. 1 shows a structural schematic diagram of a multi-scale deep supervision based reverse attention model;

FIG. 2 shows a schematic diagram of a multi-scale feature learning module; and

FIG. 3 shows a schematic diagram of a prediction model.

### DETAILED DESCRIPTION OF THE PREFERRED EMBODIMENTS

The following provides a detailed description of various exemplary embodiments of the invention, the detailed description shall not be construed as a limitation of the invention, but shall be construed as a more detailed description of certain aspects, characteristics and embodiments of the invention.

It is understood that the terms mentioned in the invention are only configured to describe particular embodiments, and are not intended to limit the invention. In addition, the numerical range mentioned in the invention shall be understood to mean that each intermediate value between the upper and lower limits of the range is also specifically disclosed. Each smaller range between any stated value or intermediate value in the stated range and any other stated value or intermediate value in the range is also included in the invention. The upper and lower limits of these smaller ranges may be independently included or excluded in the range.

Unless otherwise stated, all technical and scientific terms used in the invention have the same meanings normally understood by persons of ordinary skill in the art. Although the invention only describes preferred methods and materials, any methods and materials similar or equivalent to those described in the invention may also be used in the embodiments or tests of the invention. All references referred to in this specification are incorporated by citation to disclose and describe methods and/or materials relevant to the references. In the presence of conflicts with any incorporated references, the contents of this manual shall prevail.

Many improvements and changes of the embodiments of the invention may be made without departing from the scope or spirit of the invention, which is obvious to persons of ordinary skill in the art. Other embodiments derived from the description of the invention are obvious to persons of ordinary skill in the art. The description and embodiments of the invention are exemplary only.

The terms “contain”, “include”, “have” and “with” used in this invention are open terms, that is, they mean including but not limited to.

Unless otherwise specified, the “part” mentioned in the invention shall be construed as in part by mass.

### Embodiment 1

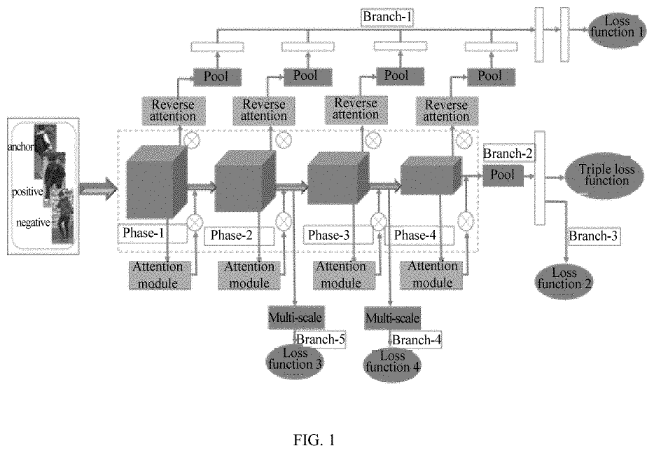

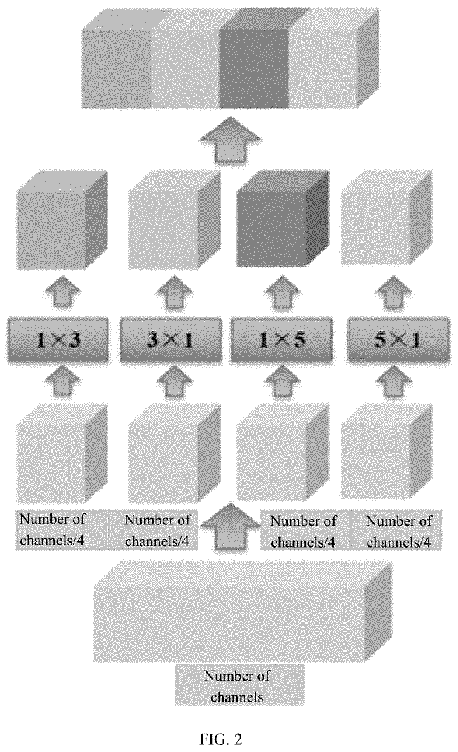

The structural schematic diagram of the multi-scale deep supervision based reverse attention model provided by the invention is shown in FIG. 1, which takes a ResNet-50 network pre-trained on an ImageNet dataset as a backbone frame to extract deep features of different hierarchies from person pictures. The last spatial down sampling operation, the original global average pool operation and fully connected layers of the ResNet-50 network are removed, and then average pool layers and linear classification layers are readded at the tail end of the network. The mid-hierarchy features generated by four phases of the ResNet-50 network are used as the inputs of the attention mechanism module and the reverse attention mechanism module. The provided multi-scale feature learning layer is shown in FIG. 2, and for reducing the GPU occupation of the trained network, only the outputs of the second and third phases are selected to participate in the deep multi-scale feature supervision operation. The entire network model performs learning under the supervision of five loss functions (ID loss1, ID loss2, ID loss3, ID loss4, ID loss5), where the five loss functions include four identification loss functions and a triple loss function. The ID loss 1 is configured to supervise the learning of reverse attention mechanism branches, the ID loss3 and the ID loss4 are configured to respectively perform the deep multi-scale feature supervision operation, and the ID loss3 and the triple loss function are respectively configured to learn global features and corresponding distance measurement methods.

In the attention mechanism module, spatial attention and channel attention are included. The channel attention module outputs a set of weight values to feature channels, and the spatial attention mechanism is configured to strengthen the attention to local important feature information.

Where, the channel attention module includes an average pool layer and two linear transformation layers. For aggregating the feature maps in the channels, a global average pool operation is carried out on feature maps M outputted by each phase of the network frame firstly:

MC=AvgPool(M)

Where M ∈ [symbol] ^{C×W×H},M_{C} ∈ [symbol] ^{C×1×1}

then, the two linear layers with batch normalization operations are used to estimate cross-channel attention from M_{C}. To reduce the number of parameters, the number of output nodes of the first linear layer is set as C/r, where r refers to dimensionality reduction ratio. For restoring the number of channels, the number of output nodes of the second layer is set as C. Behind the two linear layers, a batch normalization layer is configured to adjust the range of output values to be consistent with the range of channel attention values. To sum up, the output ATT_{C} of the channel attention is expressed as:

ATT_{C}=(linear1(linear2(MC)))

Where linear1, linear2 and BN respectively refer to the first linear layer, the second linear layer and the batch normalization layer.

Spatial attention module: the spatial attention is configured to emphasize or suppress deep features in different spatial positions, and the module contains two dimensionality reduction layers and two convolutional layers. The dimensionality of a feature after passing through the first dimensionality reduction layer is reduced from original M ∈ [symbol] ^{C×W×H} to M_{C} ∈ [symbol] ^{C/r×W×H}, into the two convolutional layers with a 3×3 convolution kernel, and finally, the dimensionality of the feature is further reduced to [symbol] ^{1×W×H} by using the second dimensionality reduction layer. Similar to the channel attention mechanism module, the features outputted by the second dimensionality reduction layer are processed by using the batch normalization operation. The steps above can be formulaically translated into:

ATT_{S}=(Reduction2(Conν2(Conν1(M_{S}))))

Where ATT_{S} is the output of the spatial attention module; Conν1 and Conν2 respectively refer to the two convolutional layer; and Reduction2 represents the second dimensionality reduction layer.

Fusion of attention modules: finally, channel attention and spatial attention are fused in the following ways:

ATT=σ(ATT_{C}×ATT_{S})

where, ATT refers to the output of the entire attention mechanism module; and σ represents a Sigmoid function.

Reverse attention mechanism module: the attention mechanism module outputs a set of weight values to suppress or emphasize spatial or channel features, this operation can improve the identification capacity of the features to a certain extent, but while some features are suppressed, a problem of information loss of some other features is inevitably caused. Therefore, those features suppressed by the attention mechanism module should also be used as emphasized features to support the training of the network model. For this purpose, the invention provides a reverse attention mechanism module for feature information supplement to the attention mechanism module, and the output of the reverse attention mechanism module is as follows:

ATT_{R}=1−σ(ATT_{C}×ATT_{S})

where, ATT_{R} is the output of the reverse attention mechanism module provided by the invention.

The objective of changing suppressed features into emphasized features is achieved by taking a dot product of a feature outputted by each phase and the output, then the features emphasized by the reverse attention mechanism module in each phase respectively undergo a pool operation firstly and then are spliced, and finally, the spliced features do a multi-classification task so as to support the training of the entire network model.

The deep multi-scale supervision training:

in the invention, deep supervision operations are performed by using mid-hierarchy features outputted by the second phase and third phase of the backbone network. It is noted that the two deep supervision operations are performed behind the attention mechanism module, because the deep supervision operations can be utilized to correct the accuracy of the attention of the attention mechanism module to important features. In addition, in the invention, before the deep supervision operations are performed, a multi-scale feature learning module is introduced for introducing multi-scale information in the feature learning process while deep supervision is performed on the model. As shown in FIG. 2, the multi-scale feature learning module is implemented through dividing features into four equal parts according to channels firstly; then, respectively inputting these equant feature sets into corresponding convolution operations, where the sizes of convolution kernels of the convolution operations are respectively 1×1, 3×1, 1×5 and 5×1; and finally, splicing the convoluted features so as to form a feature block.

In the invention, reasons for selecting single-dimensional convolution operations in the multi-scale feature learning module are as follows:

a) in the single-dimensional convolution operations, the number of parameters is less, so that the GPU resource occupation of the training model can be effectively reduced; and
b) in the single-dimensional convolution operations, extracted person features can be simultaneously learned from both horizontal and vertical directions, which more accords with the visual perception of human beings.

The loss functions:

Ranked List Loss (Ranked List Loss, RLL): the RLL function is a variant function of the triple loss function, in the invention, the RLL function is adopted to carry out supervised learning on the branch 2, the objective of the loss function is to enable the distance between negative sample pairs to be greater than a threshold value alpha and enable the distance between positive sample pairs to be less than a threshold value (alpha−m), where m is a positive number, and the formula of the loss function is shown as follows:

Lₘ(xᵢ, xⱼ, f)=(1−yᵢⱼ)└α−dᵢⱼ┘₊+yᵢⱼ└dᵢⱼ−(α−m┘₊

Where, yᵢⱼ=1 refers to that xᵢ and xⱼ are the same person, whereas 0 represents different persons, and dᵢⱼ is the Euclidean distance between xᵢ and xⱼ.

A hard positive sample pair set is expressed as:

P*_{c,i}={xⱼ^{c}|≠,dᵢⱼ>α−m}

A hard negative sample pair set is expressed as:

N*_{c,i}={xⱼ^{k}|≠,dᵢⱼ<α}

For extending the distance between hard negative sample pairs, the following formula needs be minimized:

$${L}_{N} ( {x}_{i}^{c} ; f ) = {\sum }_{{x}_{j}^{k} ∈ \vert {N}_{c , i}^{*} \vert} \frac{{w}_{ij}}{{\sum }_{{x}_{j}^{k} ∈ \vert {N}_{c , i}^{*} \vert} {w}_{ij}} {L}_{m} ( {X}_{i}^{c} , {X}_{j}^{c} ; f )$$

where wᵢⱼ refers to the weight of negative samples.

Similarly, for shortening the distance between hard positive sample pairs, the following formula needs to be minimized:

$${L}_{P} ( {x}_{i}^{c} ; f ) = \frac{1}{\vert {P}_{c , i}^{*} \vert} {\sum }_{{X}_{i}^{c} ∈ {P}_{c , i}^{*}} {L}_{m} ( {X}_{i}^{c} , {X}_{j}^{c} ; f )$$

The final loss function equation of RLL is expressed as:

L_{RLL}(xᵢ^{c}; f)=L_{P}(xᵢ^{c}; f)+λL_{N}(xᵢ^{c}; f)

where λ refers to weight coefficient, and is set to 1 in the invention.

Smoothed cross entropy loss functions: for alleviating the problem of overfitting of classification subnetworks, in the invention, the branch 1, the branch 3, the branch 4 and the branch 5 are trained by using smoothed cross entropy loss functions.

A label smoothed loss function is defined as:

$${q}_{i} = \{ \begin{matrix}1 - \frac{( N - 1 ) ɛ}{N} if i = y \\ \frac{ɛ}{N} otherwise\end{matrix}$$

where y refers to sample label information, i refers to a network prediction output, N refers to the number of training samples, and ε is a constant set to 0.1. Then, the label smoothed cross entropy loss function can be transformed into:

$${L}_{ID} = {\sum }_{i = 1}^{N} - {q}_{i} log ( {p}_{i} )$$

Where pi refers to the predicted output of category i.

To sum up, the entire loss function of the model is expressed as:

L=λ₁L_{RLL}+λ₂L_{ID1}+λ₃L_{ID2}+λ₄L_{ID3}+λ₅L_{ID4}

Where L refers to the entire loss function of the model, L_{IDi} (i=1,2,3,4) respectively refers to the smoothed cross entropy loss functions corresponding to the branch 1, the branch 3, the branch 4 and the branch 5, and λ1, λ2, λ3, λ4 and λ5 respectively refer to the weight of each loss function.

The prediction model:

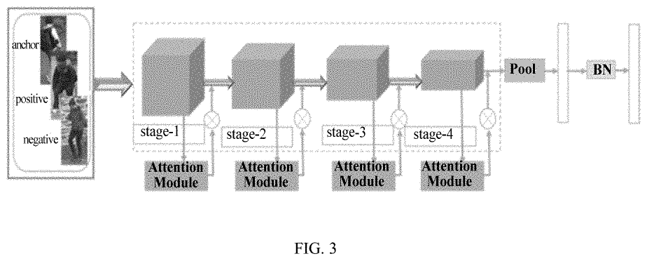

The prediction model in the invention is simple and efficient, as shown in FIG. 3, during the testing phase, the multi-scale deep supervision module, the reverse attention mechanism module and the triple branches are discarded, i.e., in a predicting network frame, the branch 1, the branch 2, the branch 4 and the branch 5 in the training model are discarded, and only the branch 3 is kept to perform feature extraction for model testing.

### Embodiment 2

For verifying the validity of the model provided by the invention, in this embodiment, relevant experimental verifications are carried out on three large public person re-identification datasets Market-1501, CUHK03 and DukeMTMC-reID. The following will describe experimental parameter settings and experimental results in detail.

Experiment details:

A network model provided by the invention is implemented on a PyTorch frame, all experiments are performed on two TITAN XP graphics cards, and the dimensionality reduction ratio parameter r in the attention mechanism module is set to 16. The size of all training pictures is set to 384×128 pixels, and a training dataset is expanded by means of random erasing and random horizontal flipping. The size of a batch processed data block for each training is set to 64, and in the batch processed data block, 16 different persons are contained, and each person has four person pictures. The weight coefficients λ₁, λ₂, λ₃, λ₄ and λ₅ of the loss functions are respectively set to 0.4, 0.1, 1, 0.03 and 0.03 according to training experiences. The total number of training rounds is set to 120, the network model is optimized by using an Adam algorithm, and the initial learning rate of the Adam algorithm is set to 3.5×10⁻⁵. Similar to previous work, the updating rule of learning rates in the network training process is shown as follows:

$$lr ( t ) = \{ \begin{matrix}3.5 \times {10}^{- 5} \times \frac{t}{10} & if t \leq 10 \\ 3.5 \times {10}^{- 4} & if 10 < t \leq 40 \\ 3.5 \times {10}^{- 5} & if 40 < t \leq 70 \\ 3.5 \times {10}^{- 6} & if 70 < t \leq 120\end{matrix}$$

Experimental comparison with advanced methods:

Experimental comparison is performed between the model of the invention and the following advanced models: PNGAN, PABR, PCB+RPP, SGGNN, MGN, G2G, SPReID, IANet, CASN, OSNet, BDB+Cut, P2-Net, etc.

### 1) Results of Evaluation on the Dataset Market-1501

According to the setting of the dataset, 751 persons and corresponding 12,936 person pictures thereof are taken as a training dataset, and the remaining 750 persons and corresponding 19,732 person pictures thereof are taken as a test set. Results of a comparative experiment on this dataset are shown in Table 1, and from Table 1, it can be seen that the identification performance of the invention exceeds those of all comparison methods. Specifically, in single-shot scenarios, the mAP, Rank-1 and Rank-5 identification rates of the invention respectively achieve 89%, 95.5% and 98.3%. Compared with a Manc network which also uses an attention mechanism and deep supervised learning, the mAP and Rank-1 identification rates of the invention are respectively increased by 6.7% and 2.4%, which proves the advancement of the invention.

TABLE 1

| Method | Publication | mAP | R-1 | R-5 |
|---|---|---|---|---|
| PNGAN | ECCV 18 | 72.6% | 89.4% | — |
| PABR | ECCV 18 | 76.0% | 90.2% | 96.1% |
| PCB + RPP | ECCV 18 | 81.6% | 93.8% | 97.5% |
| SGGNN | ECCV 18 | 82.8% | 92.3% | 96.1% |
| Manes | ECCV 18 | 82.3% | 93.1% | — |
| MGN | MM18 | 86.9% | 95.7% | — |
| FDGAN | NeurIPS 18 | 77.7% | 90.5% | — |
| DaRe | CVPR 18 | 76.0% | 89.0% | — |
| PSE | CVPR 18 | 69.0% | 87.7% | 94.5% |
| G2G | CVPR 18 | 82.5% | 92.7% | 96.9% |
| DeepCRF | CVPR 18 | 81.6% | 93.5% | 97.7% |
| SPReID | CVPR 18 | 81.3% | 92.5% | 97.2% |
| KPM | CVPR 18 | 75.3% | 90.1% | 96.7% |
| AANet | CVPR 19 | 83.4% | 93.9% | — |
| CAMA | CVPR 19 | 84.5% | 94.7% | 98.1% |
| IANet | CVPR 19 | 83.1% | 94.4% | — |
| DGNet | CVPR 19 | 86.0% | 94.8% | — |
| CASN | CVPR 19 | 82.8% | 94.4% | — |
| MMGA | CVPRW 19 | 87.2% | 95.0% | — |
| OSNet | ICCV 19 | 84.9% | 94.8% | — |
| Auto-ReID | ICCV 19 | 85.1% | 94.5% | — |
| BDB + Cut | ICCV 19 | 86.7% | 95.3% | — |
| MHN-6 | ICCV 19 | 85.0% | 95.1% | 98.1% |
| P2-Net | ICCV 19 | 85.6% | 95.2% | 98.2% |
| the invention | — | 89.0% | 95.5% | 98.3% |

### 2) Results of Evaluation on the Dataset CUHK03

In the invention, 767 persons are adopted to train on the CUHK03 dataset, and the remaining 700 persons are applied to an evaluation method of testing to evaluate the performance of the provided model. Table 2 and Table 3 respectively show the mAP and Rank-1 identification rates of the provided model and some advanced comparison methods on the CUHK03_detected and CUHK03_labeled datasets, and from these two tables, it can be observed that the model provided in the invention also achieves the most advanced performance on the CUHK03 dataset. Compared with the Mancs model of the same type, the mAP and Rank-1 identification rates of the model provided by the invention are respectively increased by at least 13 percentage points, which further verifies the effectiveness of the model.

TABLE 2

| Method | Publication | R-1 | mAP |
|---|---|---|---|
| MGN | MM18 | 66.8% | 66.0% |
| PCB + RPP | ECCV 18 | 63.7% | 57.5% |
| Manes | ECCV 18 | 65.5% | 60.5% |
| DaRe | CVPR 18 | 63.3% | 59.0% |
| CAMA | CVPR 19 | 66.6% | 64.2% |
| CASN | CVPR 19 | 71.5% | 64.4% |
| OSNet | ICCV 19 | 72.3% | 67.8% |
| Auto-ReID | ICCV 19 | 73.3% | 69.3% |
| BDB + Cut | ICCV 19 | 76.4% | 73.5% |
| MHN-6 | ICCV 19 | 71.7% | 65.4% |
| P2-Net | ICCV 19 | 74.9% | 68.9% |
| the invention | — | 78.8% | 75.3% |

TABLE 3

| Method | Publication | R-1 | mAP |
|---|---|---|---|
| MGN | MM18 | 68.0% | 67.4% |
| PCB + RPP | ECCV 18 | — | — |
| Manes | ECCV 18 | 69.0% | 63.9% |
| DaRe | CVPR 18 | 66.1% | 61.6% |
| CAMA | CVPR 19 | 70.1% | 66.5% |
| CASN | CVPR 19 | 73.7% | 68.0% |
| OSNet | ICCV 19 | — | — |
| Auto-ReID | ICCV 19 | 77.9% | 73.0% |
| BDB + Cut | ICCV 19 | 79.4% | 76.7% |
| MHN-6 | ICCV 19 | 77.2% | 72.4% |
| P2-Net | ICCV 19 | 78.3% | 73.6% |
| the invention | — | 81.0% | 78.2% |

### 3) Results of Evaluation on the Dataset DukeMTMC-reID

As shown in Table 4, the mAP and Rank-1 identification rates of the model provided by the invention on the DukeMTMC-Reid dataset respectively reach 79.2% and 89.4%. Compared with the currently most advanced method MMN-6, the two identification rates are respectively increased by 2% and 0.3%.

TABLE 4

| Method | Publication | mAP | R-1 | R-5 | R-10 |
|---|---|---|---|---|---|
| G2G | CVPR 18 | 66.4% | 80.7% | 88.5% | 90.8% |
| DeepCRF | CVPR 18 | 69.5% | 84.9% | 92.3% | — |
| SPReID | CVPR 18 | 71.0% | 84.4% | 91.9% | 93.7% |
| PABR | ECCV 18 | 64.2% | 82.1% | 90.2% | 92.7% |
| PCB + RPP | ECCV 18 | 69.2% | 83.3% | 90.5% | 95.0% |
| SGGNN | ECCV 18 | 68.2% | 81.1% | 88.4% | 91.2% |
| Manes | ECCV 18 | 71.8% | 84.9% | — | — |
| MGN | MM18 | 78.4% | 88.7% | — | — |
| AANet | CVPR 19 | 74.3% | 87.7% | — | |
| CAMA | CVPR 19 | 72.9% | 85.8% | | |
| IANet | CVPR 19 | 73.4% | 87.1% | — | — |
| DGNet | CVPR 19 | 74.8% | 86.6% | — | — |
| CASN | CVPR 19 | 73.7% | 87.7% | — | — |
| OSNet | ICCV 19 | 74.8% | 86.6% | — | — |
| Auto-ReID | ICCV 19 | 75.1% | 88.5% | — | — |
| BDB + Cut | ICCV 19 | 76.0% | 8900% | — | — |
| P2-Net | ICCV 19 | 73.1% | 86.5% | 93.1% | 95.0% |
| MHN-6 | ICCV 19 | 77.2% | 89.1% | 94.6% | 96.5% |
| the invention | — | 79.2% | 89.4% | 94.7% | 96.0% |

Ablation experiments:

The embodiment shows the results of some ablation experiments so as to demonstrate the effectiveness of each module provided in the model. All ablation experiments are performed on the CUHK03_labeled dataset, and experimental details and experimental results are shown as follows:

### 1) Effectiveness of Reverse Attention Mechanism Module

For verifying the influence of the provided reverse attention mechanism module on the performance of the entire model, the reverse attention mechanism module in the model is discarded and named as Our/_{Reverse}, and then experimentally verified on the CUHK03_labeled dataset, and experimental results are shown in Table 5. From the table, it can be observed that when the reverse attention mechanism module is discarded, the identification performance of the network model decreases, specifically, when no reverse attention mechanism module acts, the mAP and Rank-1 accuracies of the network model are respectively reduced by 1.5% and 3.7%.

TABLE 5

| Model | mAP | R-1 | R-5 |
|---|---|---|---|
| Our/ᵣₑᵥₑᵣₛₑ | 76.7% | 77.3% | 91.3% |
| Our | 78.2% | 81.0% | 92.0% |

From the results above, it can be concluded that the reverse attention mechanism module provided in the invention plays an active promotion role in the feature learning of the network model.

### 2) Effectiveness of Deep Multi-scale Supervision Module

For verifying the effectiveness of the deep multi-scale supervision module provided by the invention, in this embodiment, the branch 4 and the branch 5 in the original network model are discarded, and then the network is named as Our/ₛᵤₚₑᵣᵥᵢₛᵢₒₙ. Experimental results of comparison between the network model and the original network model on the CUHK03_labeled dataset are shown in Table 6, and from the table, it can be seen that after the deep multi-scale supervision module of the invention is introduced, the mAP and Rank-1 accuracies of the Our/ₛᵤₚₑᵣᵥᵢₛᵢₒₙ model are respectively increased by 1.3% and 1.9%, thereby proving that the provided deep multi-scale supervision module is effective in the provided model.

TABLE 6

| Model | mAP | R-1 | R-5 |
|---|---|---|---|
| Our/ₛᵤₚₑᵣᵥᵢₛᵢₒₙ | 76.9% | 79.1% | 91.6% |
| Our | 78.2% | 81.0% | 92.0% |

The experimental results on the three person re-identification common datasets show that the provided network model achieves the currently most advanced identification performance. In addition, in the multi-scale feature learning module of the invention, the entire feature is only divided into four feature sets, and it is believed that if the entire feature is divided into more feature sets, the identification performance of the integral network can be further improved. Moreover, in an exemplary embodiment, the multi-scale feature learning module, the attention mechanism module, the reverse attention mechanism module, the deep supervision module, the loss functions, the average pool layers, the linear layers and the branches are software modules stored in a memory and executable by a processor coupled to the memory.

The foregoing embodiments are merely examples for clearly describing the preferable embodiments of the invention, and not intended to limit the scope of the invention, and other various forms of variations or modifications of the technical solution made by those of ordinary skill in the art, without departing from the design spirit of the invention, shall fall within the protection scope of the claims of the invention.

What is claimed is:

1. A multi-scale deep supervision based reverse attention model, comprising: an input end, a multi-scale feature learning module, an attention mechanism module, a reverse attention mechanism module, a deep supervision module, a plurality of loss functions, a plurality of average pool layers, a plurality of linear layers and a plurality of branches; wherein
the multi-scale feature learning module, the attention mechanism module, the reverse attention mechanism module, the deep supervision module, the plurality of loss functions, the plurality of average pool layers, the plurality of linear layers and the plurality of branches are software modules stored in a memory and executable by a processor coupled to the memory;
the input end is configured to input features of different hierarchies extracted from a plurality of person pictures;
the multi-scale feature learning module is configured to carry out multi-scale learning and training on the features, and comprises four phases: a first phase, a second phase, a third phase and a fourth phase, and the four phases input feature sets and output feature maps;
the attention mechanism module is configured to strengthen an attention to local important feature information;
the reverse attention mechanism module is configured to change features suppressed by the attention mechanism module into emphasized features, and is complementary to the attention mechanism module;
the deep supervision module is configured to correct an accuracy of the attention of the attention mechanism module to important features;
the plurality of branches comprise a branch 1, a branch 2, a branch 3, a branch 4 and a branch 5;
the multi-scale feature learning module, the reverse attention module, the plurality of average pool layers and the plurality of loss functions are successively connected;
the second phase of the multi-scale feature learning module is successively connected to the deep supervision module, the branch 5 and the plurality of loss functions through the attention mechanism module;
the third phase of the multi-scale feature learning module is successively connected to the deep supervision module, the branch 4 and the plurality of loss functions through the attention mechanism module;
the first, second, third and fourth phases of the multi-scale feature learning module, the plurality of average pool layers and the branch 2 are successively connected;
the branch 2 is directly connected to the plurality of loss functions; and
the branch 2 is also connected to the plurality of loss functions through the branch 3.

2. The multi-scale deep supervision based reverse attention model according to claim 1, wherein single-dimensional convolution operations are carried out in the multi-scale feature learning module.

3. The multi-scale deep supervision based reverse attention model according to claim 1, wherein the attention mechanism module comprises a channel attention module and a spatial attention module, the channel attention module is configured to output a set of weight values to feature channels, the spatial attention module is configured to strengthen the attention to local important feature information, the channel attention module and the spatial attention module are both configured to process feature maps outputted by each phase of the multi-scale feature learning module, and the channel attention module and the spatial attention module are fused:
ATT=σ(ATT_{C}×ATT_{S})
where ATT refers to an output of the whole attention mechanism module, σ refers to a Sigmoid function, ATT_{C} refers to the output of the channel attention module, and ATT_{S} refers to an output of the spatial attention module.

4. The multi-scale deep supervision based reverse attention model according to claim 3, wherein the channel attention module comprises an average pool layer and two linear layers, and the output of the channel attention module is implemented through steps that: firstly, the feature map passes through the average pool layer to carry out a global average pool operation; then, the feature map passes through the two linear layers, a first one of the two linear layers is configured to reduce the number of parameters, and a second one of the two linear layers is configured to recover the number of channels; and a batch normalization operation is carried out on the feature map after passing through the two linear layers, so that a range of output values and a range of channel attention values are adjusted to be consistent.

5. The multi-scale deep supervision based reverse attention model according to claim 3, wherein the spatial attention module comprises two convolutional layers and two dimensionality reduction layers, and the output of the spatial attention module is implemented through steps that: firstly, the feature map passes through one of the two dimensionality reduction layers to carry out dimensionality reduction; then, the feature map is successively inputted into the two convolutional layers, and then enters the other one of the two dimensionality reduction layers to carry out further dimensionality reduction; and finally, a batch normalization operation is performed on the feature map.

6. The multi-scale deep supervision based reverse attention model according to claim 1, wherein in the reverse attention mechanism module, a method for changing the suppressed feature into the emphasized feature is implemented through taking a dot product of a feature outputted by each phase and an output, where the output is:
ATT_{R}=1−σ(ATT_{C}×ATT_{S})
where, ATT_{R} refers to the output of the reverse attention mechanism module.

7. The multi-scale deep supervision based reverse attention model according to claim 1, wherein the deep supervision module is also configured to introduce multi-scale information in a feature learning process.

8. The multi-scale deep supervision based reverse attention model according to claim 1, wherein the plurality of loss functions comprise four identification loss functions, four smoothed cross entropy loss functions and a triple loss function; the four identification loss functions comprise an ID loss1, an ID loss2, an ID loss3 and an ID loss4, the four smoothed cross entropy loss functions are respectively configured to train the branch 1, the branch 3, the branch 4 and the branch 5, and the triple loss function is a ranked list loss function.

9. The multi-scale deep supervision based reverse attention model according to claim 8, wherein the ID loss 1 is configured to supervise the learning of the reverse attention mechanism module, the ID loss2 and the triple loss function are respectively configured to learn global features and corresponding distance measurement methods, and the ID loss3 and the ID loss4 are configured to perform deep multi-scale feature supervision operations.

10. The multi-scale deep supervision based reverse attention model according to claim 1, wherein in a predicting process, the model only comprises the input end, the multi-scale feature learning module, the attention mechanism module, the plurality of average pool layers, the plurality of linear layers and the branch 3.
